(19) United States
(12) Patent Application Publication
(10) Pub. No.: US 2004/0265764 A1
(43) Pub. Date: Dec. 30, 2004

(54) Pollution abatement with heat engine

(76) Inventors: Joseph M. Klobucar, Ann Arbor, MI (US); Gordon Harbison, Canton, MI (US); David J. Cole, Canton, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/872,833

(22) Filed: Jun. 21, 2004

Related U.S. Application Data
(60) Provisional application No. 60/480,887, filed on Jun. 24, 2003.

(51) Int. Cl. F27D 19/00

(52) U.S. Cl. 432/53; 417/313; 417/572

(57) ABSTRACT

A thermal oxidizer assembly for abatement of process emissions uses an abatement chamber where process emissions are abated generating heated gases. A converter is in fluid communication with the abatement chamber for receiving the heated gases from the abatement chamber. The converter includes a heat engine for converting thermal energy disposed in the heated gases to useable mechanical energy.

### RELATED APPLICATION

This application claims priority to a provisional patent application filed Jun. 24, 2003, Ser. No. 60/480,887.

### BACKGROUND OF THE INVENTION

This invention relates generally to a thermal oxidizer used for the abatement of process emissions received from an industrial process. More particularly, the invention relates to a thermal oxidizer having a converter for converting thermal energy generated in the thermal oxidizer to electrical energy. Process emissions generated by industrial processes such as, for example, industrial painting, contain combustible contaminants that if released into the atmosphere, are known to pollute the environment. Pursuant to government environmental regulations, these types of contaminants are abated in environmental control equipment such as thermal oxidizers. These thermal oxidizers make use of combustible fuels inside a combustion chamber for raising the temperature of the process emissions to a level known to oxidize or break down the contaminants to elemental form.

One type of thermal oxidizer that is frequently used in industrial processes, is known as a regenerative thermal oxidizer. This type of thermal oxidizer generates temperatures of up to and even above 900° F. in the combustion chamber. While this thermal energy has been used to heat adsorption media to strip oxidized contaminants from a cleaned air stream, no other attempt has been made to capture the heat energy generated in the combustion chamber. Thus, a substantial amount of heat energy derived from contaminants such as, for example, volatile organic compounds, and by combustion fuel that is sometimes added to the combustion chamber is lost. Therefore, it would be desirable to capture the heat energy generated in the thermal oxidizer and convert that heat energy to a form that may improve process efficiencies to reduce overall industrial power requirements.

### SUMMARY OF THE INVENTION

A process for abating contaminants from a stream of process emissions in a combustion chamber includes operably connecting the combustion chamber to a converter. A stream of combustion fuel and a stream of combustion air are provided to the combustion chamber along with the stream of process emissions. The combustion fuel charges a burner that raises the temperature in the combustion chamber to the oxidization temperature of the contaminants disposed in the process emissions.

A stream of bypass air is drawn from the combustion chamber and transferred to the converter. The stream of combustion air and the stream of bypass air have generally equal volumetric flow rates.

Generally balancing the volumetric flow rate of the combustion air being introduced to the combustion chamber and the bypass air being transferred from the combustion chamber to the converter has produced the unexpected result by providing more energy than is being introduced to the combustion chamber via the combustion fuel. Additional energy is produced at no additional cost to the process. It should be understood to those of skill in the art that the contaminants disposed in the process emissions also include latent heat energy providing a source of fuel to the combustion chamber. However, the unexpected result of producing more energy from the converter than is being introduced to the combustion chamber by the combustion fuel is only derived when the volumetric flow rate of the combustion air is generally balanced with the volumetric flow rate of the bypass air. Through an appropriate choice of converters, the thermal energy is converted to electrical energy that is used either for running the thermal oxidizer or is reintroduced into the industrial process, thereby reducing the manufacturing cost.

Other advantages and meritorious features of this invention will be more fully understood from the following description of the preferred embodiments, the appended claims and the drawings, a brief description of which follows.

### BRIEF DESCRIPTION OF THE DRAWINGS

FIG. 1 shows a schematic of the inventive thermal oxidizer assembly; and

FIG. 2 shows an inventive regenerative oxidizer with an attached converter to generate electrical energy.

### DETAILED DESCRIPTION OF THE PREFERRED EMBODIMENT

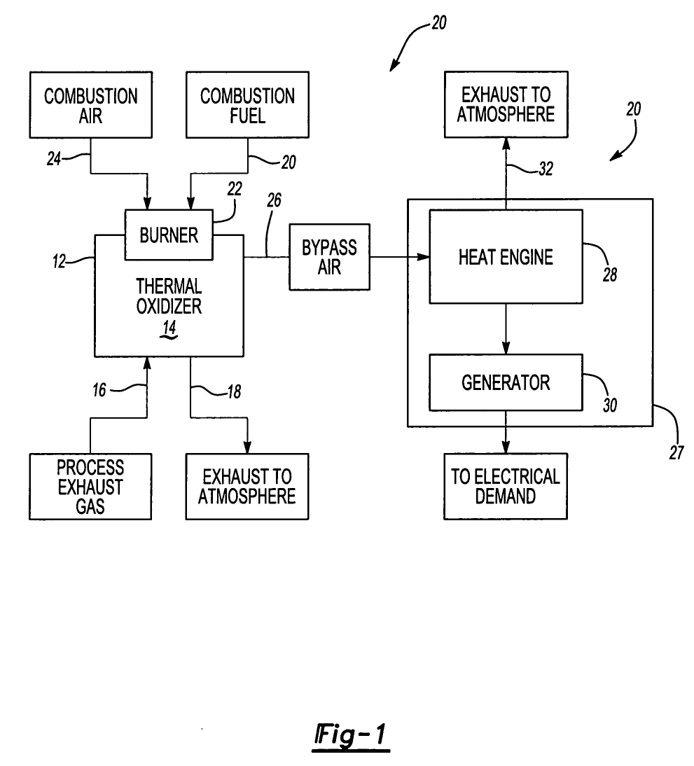

Referring to FIG. 1, a schematic of the inventive thermal oxidizer assembly is generally shown at 10. A thermal oxidizer 12 includes a combustion chamber 14 wherein process emissions are oxidized as will be explained further below. A process emission inlet 16 feeds process emissions into the thermal oxidizer 12 and subsequently into the oxidation chamber 14 for abatement of the process emissions. The process emissions include volatiles produced by such processes as coating, laminating, painting, or drycleaning processes. These emissions generally include particulate matter along with volatile organic components that are combustible and abated inside the thermal oxidizer 12. An exhaust outlet 18 receives abated gases from the combustion chamber 14 and vents the gases to atmosphere. Occasionally, enough volatile organic components are included in the process emissions to fuel the combustion chamber 14 in the absence of any additional combustible fuel. However, as shown in FIG. 1, the thermal oxidizer 12 includes a combustion fuel inlet 20 through which a combustible fuel such as, for example, natural gas is injected through a burner 22 into the combustion chamber 14. In order to balance the abatement process, a combustion air inlet 24 routes combustion air preferably through the burner 24 and subsequently into the combustion chamber 14.

A bypass line 26 connects a converter 27 to the thermal oxidizer 12. Preferably, the bypass line 26 fluidly connects the combustion chamber 14 of the thermal oxidizer 12 to a heat engine 28. However, the bypass line 26 may also be connected to a residual process chamber (not shown) of the thermal oxidizer if necessary, such as, for example, a regeneration chamber 42 as will be explained further below. The heat engine 28 is preferably a Stirling cycle engine or equivalent external combustion engine. The Stirling cycle engine uses thermal expansion and contraction working gases to convert thermal energy to mechanical energy as is known to those of skill in the art. The mechanical energy is used to do useful work such as, for example, generating electrical energy for later use as will be explained further below. A preferred Stirling cycle engine suitable for the application disclosed herein is produced by STM Power, Inc., Ann Arbor, Mich. However, other equivalent sterling type engines may also be used.

The heat engine 28 is operably connected to an electrical generator 30, thereby driving the generator 30 to produce electrical energy. The electrical energy is directed back to the thermal oxidizer 12 to operate the thermal oxidizer 12 or, more preferably, directed to another operation in the manufacturing process requiring electrical energy.

The gases received by the heat engine 28 via the bypass line 26 are vented to the atmosphere through a heat engine exhaust line 32. Preferably, the amount of gas transferred to the heat engine 26 is balanced with the amount of combustion air that is introduced to the thermal oxidizer. By balancing the mass flow of the combustion air and the gases extracted through the bypass line 26, a net improvement in the thermal oxidizer heat recovery efficiency is recognized. This offsets by half or more of the energy extracted from the combustion chamber 14. The net effect is that the heating value of the increase in fuel consumption for the thermal oxidizer 12 is one-half or less than the thermal energy extracted. This unexpected result seemingly produces energy not being introduced to the combustion chamber 14.

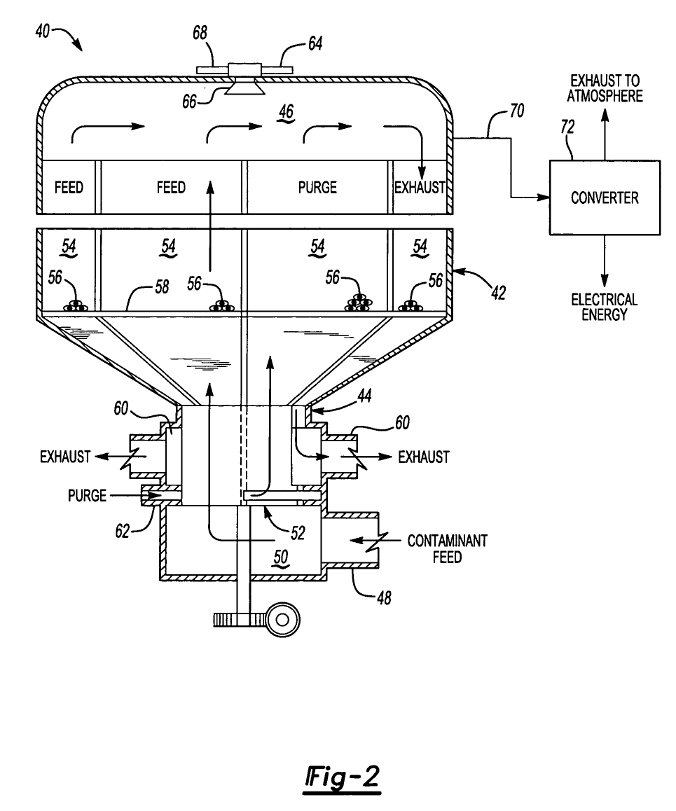

An additional embodiment is shown in FIG. 2 where the thermal oxidizer comprises a regenerative thermal oxidizer (RTO) generally shown at 40. The RTO includes a regeneration chamber 42 having a flow control valve 44 disposed at its lower end and a combustion chamber 46 disposed at an upper end. Process emissions are admitted through process inlet 48 and passed through a plenum 50 upwardly into a valve core 52. Individual segments 54 are defined as pie-shaped passages and are filled preferably with ceramic media 56 used to store and release heat. Each segment 54 is designated, on a rotating basis, to either receive feed gases, receive purge gas, or accept exhaust gas during operation as designated in FIG. 2.

The flow control valve 44 includes an annular exhaust manifold 58 where cleaned and heated gas is passed through other of the segments 54 and out of the RTO through exhaust outlets 60. Preferably, the flow control valve 44 includes a purge line 62 through which purged air is routed through a select segment 54 into the combustion chamber 46 and out through the exhaust outlet 60 via select segment 54.

As known to those of skill in the art, the flow control valve 44 rotates to alternate the segment 54 receiving process emissions, exhaust gases, and purge gas. The full operation of the RTO is set forth in U.S. Pat. No. 5,016,547, which is incorporated herein by reference. In addition, the present invention is also incorporated into rotary type thermal oxidizers of the kind disclosed in U.S. Pat. No. 5,788,744, which is also incorporated herein by reference.

As set forth above, it may be necessary to introduce fuel gas into the combustion chamber 46. Therefore, a fuel gas inlet 64 introduces fuel gas into the combustion chamber 46 to fuel gas burner 66. Fuel gas burner 66 raises the temperature in the combustion chamber 46 to, for example, over 800° C. or a temperature known to oxidize the contaminants disposed in the process exhaust gas. As also set forth above, combustion air is introduced to the fuel burner 66 through combustion air inlet 68 to balance the combustion reaction taking place in the burner 66. A bypass line 70 vents heated gases from the combustion chamber 46 to a converter 72. The converter 72 includes a heat engine 28 and a generator 30 as shown in FIG. 1. The converter 72 converts thermal energy disposed in the heated gases to electrical energy as also set forth above.

The invention has been described in an illustrative manner, and it is to be understood that the terminology which has been used is intended to be in the nature of words of description rather than of limitation.

Obviously, many modifications and variations of the present invention are possible in light of the above teachings. It is, therefore, to be understood that within the scope of the appended claims, wherein reference numerals are merely for convenience and are not to be in any way limiting, the invention may be practiced otherwise than as specifically described.

What is claimed is:

1. A method of reclaiming energy from a pollution abatement assembly, comprising the steps of:
providing a heat engine operably connected to said assembly;
providing a stream of process emissions to said assembly;
providing a stream of combustion fuel to said assembly for assisting abatement of process emissions by raising the temperature of the process emissions;
abating pollutants disposed in said stream of process emissions;
providing a stream of combustion air to said assembly for assisting abatement of process emissions; and
extracting a stream of abated air from said assembly and inserting the stream of abated air into said heat engine thereby generating mechanical energy from the abated air.

2. The method as set forth in claim 1, wherein said step of extracting a stream of abated air is further defined by extracting said stream of abated air at a mass flow rate generally equal to a mass flow rate of said combustion air provided to said assembly.

3. The method as set forth in claim 1, further including the step of venting said bypass air from said heat engine.

4. The method as set forth in claim 1, further including the step providing said assembly with a combustion chamber wherein the process emissions are abated.

5. The method as set forth in claim 4, wherein said step of extracting said stream of bypass air from said assembly is further defined by extracting said stream of bypass air from said combustion chamber.

6. The method as set forth in claim 1, wherein said step of providing combustion fuel to said assembly is further defined by increasing a mass flow rate of said combustion fuel thereby providing an increase in the amount of electrical energy produced by said heat engine.

7. The method as set forth in claim 1, wherein said step of generating mechanical energy is further defined by operably connecting an electrical generator to said heat engine thereby converting said mechanical energy to electrical energy.

8. The method as set forth in claim 1, wherein said step of abating pollutants disposed in said stream of process emissions is further defined by oxidizing the pollutants disposed in said stream of process emissions.

9. The method as set forth in claim 1, wherein said step of producing mechanical energy is further defined by producing more mechanical energy than is included in said stream of combustion fuel provided to said assembly.

10. A process for abating contaminants from a stream of process emissions in a combustion chamber whereby said combustion chamber is operably connected to a converter, comprising the steps of:
providing a stream of combustion fuel and a stream of combustion air to said combustion chamber wherein said combustion fuel includes a first energy component;
transferring a stream of bypass air from said combustion chamber to said converter;
generating a mechanical energy in said converter providing a second energy component greater than said first energy component.

11. The method as set forth in claim 10, further including the step of balancing a mass flow rate of said stream of combustion air and a mass flow rate of said stream of bypass air.

12. The method as set forth in claim 10, further including the step of providing a heat engine and an electrical generator, whereby said heat engine receives bypass air from said combustion chamber thereby generating mechanical energy for driving said electrical generator thereby producing electrical energy.

13. The method as set forth in claim 10, further including the step of venting bypass air from said converter to the atmosphere.

14. The method as set forth in claim 10, further including the step of venting abated air from said combustion chamber to the atmosphere.

15. A thermal oxidizing assembly for abating contaminants from a stream of process emissions, comprising:
a combustion chamber for heating the stream of process emissions to a temperature known to oxidize contaminants disposed in the process emissions thereby generating a stream of heated, clean air;
a converter fluidly connected to said combustion chamber for receiving the stream of heated, clean air; and
wherein said converter includes a heat engine and an electrical generator cooperable with said heat engine for converting the stream of heated air to electrical energy.

16. An assembly as set forth in claim 15, wherein said converter comprises an external combustion engine.

17. An assembly as set forth in claim 15, wherein said converter comprises a Stirling cycle engine.

18. An assembly as set forth in claim 15, wherein said assembly includes a combustion fuel inlet for providing combustion fuel to said combustion chamber.

19. An assembly as set forth in claim 18, wherein said assembly includes a combustion air inlet for providing combustion air to said combustion chamber.

20. An assembly as set forth in claim 19, wherein said combustion air inlet provides combustion air to said combustion chamber having a first volumetric flow rate and the stream of heated, clean air includes a second volumetric flow rate, said first volumetric flow rate being generally equal to said second volumetric flow rate.

21. An assembly as set forth in claim 15, wherein said converter is operably connected to said thermal oxidizer thereby providing electrical energy to said thermal oxidizer.

22. An assembly as set forth in claim 15, wherein said thermal oxidizer comprises a Rotary Thermal Oxidizer.

23. An assembly as set forth in claim 22, wherein the stream of heated, clean air is provided from an exhaust outlet from said thermal oxidizer.

24. A thermal oxidizer assembly for abatement of process emissions, comprising:
an abatement chamber wherein process emissions are abated thereby generating heated gases;
a heat recovery device in fluid communication with said abatement chamber thereby receiving the heated gases from said abatement chamber; and
a converter in fluid communication with said abatement chamber for receiving the heated gases from said combustion chamber and converting thermal energy disposed in the heated gases to mechanical energy.

25. An assembly as set forth in claim 24, wherein converter comprises a Stirling engine.

26. An assembly as set forth in claim 24, further including a fuel input line in fluid communication with said abatement chamber for providing fuel to said abatement chamber.

27. An assembly as set forth in claim 26, further including a combustion air inlet in fluid communication with said abatement chamber for providing combustion air to said abatement chamber.

28. An assembly as set forth in claim 27, further including a bypass line for transferring abated process emissions from said abatement chamber to said converter.

29. An assembly as set forth in claim 28, wherein said combustion air inlet provides combustion air at a generally equivalent volumetric rate to said transfer of abated process emissions to said converter.

30. An assembly as set forth in claim 24, wherein said converter comprises a heat engine operably connected to an electrical generator for generating electrical energy.

31. An assembly as set forth in claim 30, wherein said electrical generator is operably connected to said thermal oxidizer for providing electrical energy to said thermal oxidizer.

32. An assembly as set forth in claim 31, wherein said heat engine vents abated process emissions received from said combustion chamber to the atmosphere.

33. As assembly as set forth in claim 24, wherein said abatement chamber comprises an oxidation chamber.
